(19) United States
(12) Patent Application Publication
(10) Pub. No.: US 2015/0293204 A1
(43) Pub. Date: Oct. 15, 2015

(54) METHOD AND DEVICE FOR DETERMINING THE PROPAGATION TIME OF A SURFACE ACOUSTIC WAVE FILTER

(71) Applicant: Sagem Defense Securite, Boulogne-Billancourt (FR)

(72) Inventors: Francis Chaminadas, Boulogne-Billancourt (FR); Jean-Christophe Le Liboux, Boulogne-Billancourt (FR)

(21) Appl. No.: 14/647,815

(22) PCT Filed: Dec. 10, 2013
(86) PCT No.: PCT/EP2013/076028

§ 371 Date: May 27, 2015

(30) Foreign Application Priority Data
Dec. 10, 2012 (FR) 1203343

(51) Int. Cl. G01S 5/02; G01S 5/04; G01S 19/24

(52) U.S. Cl. CPC G01S 5/0221; G01S 19/24; G01S 5/04

(57) ABSTRACT

The invention relates to a receiver of a system for positioning by satellite, including: a channel filter (SAW) in which a signal transmitted by satellite and received by the receiver is propagated along a direct path and indirect paths in an odd order; upstream from the channel filter, a tracking loop being controlled by means of a control correlator (C1), the receiver being characterized in that it comprises: an offset register (RD) configured to generate a plurality of local replicas (S5) of said code, which are offset from one another such as to cover a time window corresponding to twice the uncertainty on an estimate of a propagation time when passing directly through the channel filter, a second correlator (C2) offset relative to the control correlator by a time corresponding to twice said propagation time estimate when passing directly through the channel fitter, said second correlator being configured to correlate the code for spreading the signal transmitted by the satellite with said local replicas generated by the offset register, and to detect a correlation peak corresponding to the acquisition of the signal transmitted by the satellite and propagated in the channel filter along a triple indirect path.

### FIELD OF THE INVENTION

The field of the invention concerns receivers for GNSS satellite positioning (Global Navigation Satellite System). More specifically the invention sets out to reduce error which may affect positioning data delivered by a said receiver, by evaluating the propagation time of satellite signals within the receiver and in particular within the channel filter of a said receiver.

The invention applies in particular to receivers of signals transmitted by GPS (Global Positioning Systems), Glonass, Galileo systems and other similar positioning systems using satellites.

### BACKGROUND OF THE INVENTION

A satellite positioning receiver uses signals transmitted by a plurality of satellites in orbit around the earth.

It is in particular via a plurality of channels, each one associated with a satellite, that the tracking of a satellite (tracking of a satellite signal) can be set up.

Each of the satellites transmits a phase-modulated signal over one or more given frequencies by combining a pseudo-random spreading code and a navigation message containing inter alia epheremis data on the satellites (i.e. the elements defining their orbit and their variations as a function of time).

Positioning via satellites measures the propagation of the radiofrequency signal transmitted by each of the satellites. These propagation times multiplied by the speed of transmission of the signal give the satellite-receiver distances (better known to those skilled in the art as “pseudo-distances”). These associated with the position of the satellites calculated by means of epheremis data allow calculation of the position of the receiver and the deviation of its clock relative to those of the satellites.

Since the rate of propagation of the radiofrequency signal is not constant along the travelled pathway, in particular in the ionosphere, the calculated distances are distorted due to lengthening of the propagation time. For a substantial reduction in errors affecting propagation times, a correction called dual-frequency correction must be made. This uses the difference in propagation times of two signals transmitted by each satellite on two different frequency bands.

The difference in measured propagation times also comprises the difference in propagation times within the receiver which is nonzero on account of the processing of the two signals on two separate paths. The uncertainty regarding the receiver-related difference in propagation times, although limited to a few nanoseconds, translates after dual-frequency correction as locating errors of a several metres. The uncertainty of this difference in propagation times is related to the fact that they are not constant from one receiver to another, that they are temperature-dependent and are further affected by ageing of the receiver.

The dominant contributor towards the propagation time of a GNSS receiver and therefore to the uncertainty regarding difference in propagation times is the channel filter. This is an essential part of a radio receiver for strong attenuation of all out-of-band parasite signals which could saturate the receiver. This filter is almost always a Surface Acoustic Wave filter (SAW) on account of its numerous advantages: selectivity, phase linearity, bulk, weight etc.

After dual-frequency correction, the positioning error of a GNSS receiver using SAW filters can be significantly reduced if there is precise knowledge of their TP values (nominal value, changes with temperature and ageing.

The solution currently used:

reduces the dispersion of propagation time by sorting the SAW filters derived from one same wafer;

compensates for drift in propagation time through ageing by new calibration during a maintenance repair and overhaul phase (MRO).

However, despite sorting at production it remains necessary to make provisions for a significant error budget (in the order of magnitude of the accuracy of the GNSS system itself) in order to be able to track time and temperature behaviour of SAW filters.

### DESCRIPTION OF THE INVENTION

It is the objective of the invention to increase the accuracy of a GNSS receiver through better knowledge of the propagation time through the channel filter of the receiver.

For this purpose, the invention according to a first aspect proposes a receiver for satellite positioning system, comprising:

a channel filter comprising an input transducer and output transducer, wherein the propagation of a signal transmitted by a satellite and received by the receiver follows a direct pathway corresponding to direct passing between the input transducer and output transducer and along indirect pathways corresponding to 2n+1 times the direct pathway due to multiple reflections on the input transducer and output transducer, n being an integer greater than or equal to 1;

downstream of the channel filter, a tracking loop controlled by means of a control correlator centred on a correlation peak between a spreading code of the signal transmitted by the satellite and a local replica of said code generated by the receiver,

the receiver being characterized in that it comprises:

a shift register configured to generate several local replicas of said spreading code shifted from one another so as to cover a time window corresponding to twice the uncertainty of the estimated propagation time for direct propagation through the channel filter;

a second correlator offset from the control correlator by a time corresponding to twice said estimated propagation time for direct propagation through the channel filter, said second correlator being configured to correlate the spreading code transmitted by the satellite with said local replicas generated by the shift register and to detect a correlation peak, said correlation peak corresponding to the acquisition of the signal transmitted by the satellite and propagated in the channel filter along a triple indirect path.

Some preferred but non-limiting aspects of this receiver are the following:

it further comprises a computer configured to compute a pseudo-distance to the satellite using the correlation peak of the control correlator and a pseudo-distance to the satellite using the correlation peak of the second correlator, said computer also being configured to compute the direct path propagation time through the channel filter by dividing by two the difference between said pseudo-distances;

the control correlator and the second correlator integrate the correlation results on an integration time, the integration time of the second correlator being longer than the integration time of the control correlator.

According to a second aspect, the invention concerns a method to determine the propagation time of a signal transmitted by a satellite in a receiver of a satellite positioning system, the receiver comprising:

a channel filter comprising an input transducer and an output transducer, wherein the propagation of a signal transmitted by a satellite and received by the receiver travels along a direct path corresponding to direct passing between the input and output transducers and along indirect paths corresponding to 2n+1 times the direct path due to multiple reflections on the input and output transducers, n being an integer greater than or equal to 1;

downstream of the channel filter, a tracking loop controlled by a control correlator centred on a correlation peak between a spreading code of the signal transmitted by the satellite and a local replica of said code generated by the receiver,

the method being characterized by application of the following steps:

generation of several local replicas of said spreading code shifted from one another so as to cover a time window corresponding to twice the uncertainty of the estimated propagation time for direct propagation through the channel filter,

correlation, by means of a second correlator offset from the control correlator by a time corresponding to twice said estimated propagation time for direct propagation through the channel filter, of the spreading code of the signal transmitted by the satellite with said local replicas generated by the shift register, and detection of a correlation peak, said correlation peak corresponding to the acquisition of the signal transmitted by the satellite and propagated in the channel filter along a triple indirect path.

### BRIEF DESCRIPTION OF THE DRAWINGS

Other aspects, objectives and advantages of the present invention will become better apparent on reading the following detailed description of preferred embodiments thereof, given as non-limiting examples and with reference to the appended drawings in which:

FIG. 1 is a simplified schematic of a surface acoustic wave filter;

FIG. 2 illustrates the propagation of a signal along single and triple paths inside a filter according to FIG. 1;

FIG. 3 is a schematic illustrating a GNSS receiver conforming to the invention.

### DETAILED DESCRIPTION OF THE INVENTION

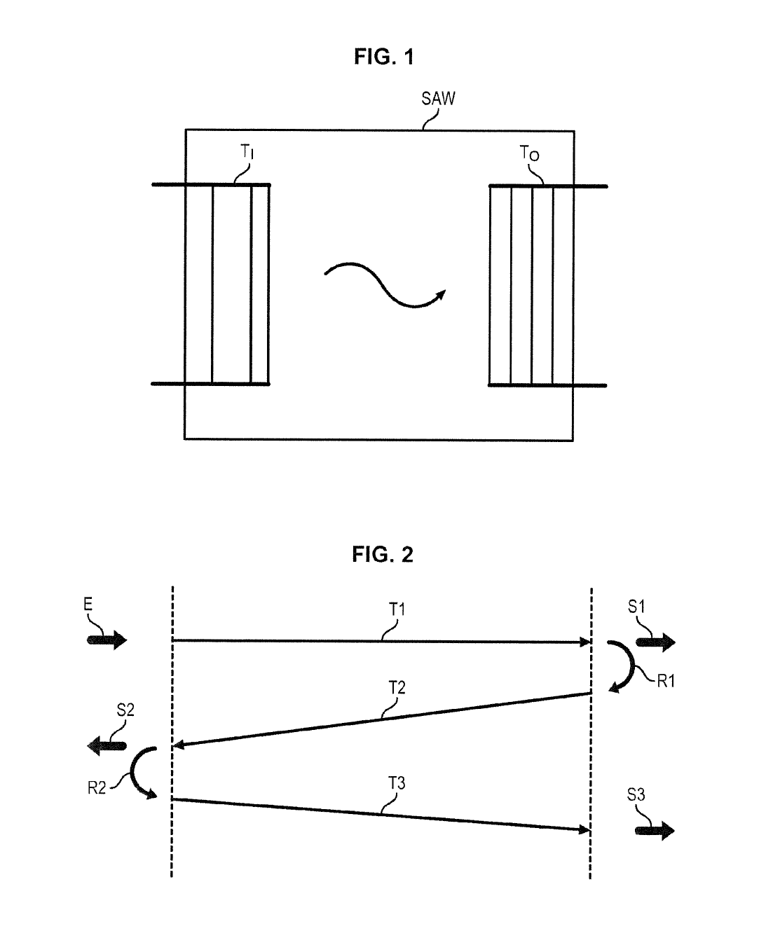

The invention according to a first aspect concerns a GNSS receiver for satellite positioning. With reference to FIGS. 1 and 2 such a receiver, as is conventional, comprises a channel filter, typically a surface acoustic wave filter SAW (to which non-limiting reference will be made as an example in the remainder hereof) which allows the selective transmitting of an acoustic wave between two transducers T_{I}, T_{O} etched on a quartz substrate. Electric-acoustic conversion and vice versa is obtained by means of the piezo-electric effect located that the input and output transducers T_{I}, T_{O}.

Since transducers are not perfect, several propagation paths T1-T3 of the acoustic waves are set up. For example, a signal E transmitted by a satellite and received by the receiver is propagated in the SAW filter along a direct path T1 corresponding to direct passing between the input and output transducers T_{I}, T_{O} to give an output signal 51.

On account of multiple reflections R1, R2 on the input and output transducers T_{I}, T_{O} (mismatch), the signal E is propagated along indirect paths corresponding to 2n+1 times the direct path, n being an integer greater than or equal to 1. A triple path corresponding to the sum of the paths T1, T2 and T3 provides an output signal S3 having a lower level than the signal S1 of the direct path, typically having a level in the order of 30 dB.

The invention proposes combining the time measuring capacities of the GNSS signals with this defect of SAW filters forming signals derived from indirect paths in order to determine the propagation time thereof. As is described in more detail below, once a satellite signal has been tracked the invention more specifically proposes to determine the pseudo-distances of its single path and triple path, then to deduce the propagation of the SAW filter by subtracting these pseudo-distances and then dividing the result by two. The difference between these pseudo-distances effectively corresponds to the additional path travelled by signal S3 of the triple path i.e. T2 +T3 as illustrated in FIG. 2.

By design, the waveform of GNSS signals allows measurement of their propagation time between the satellites by which they are transmitted and the receiver by which they are received. The carrier of a GNSS signal spectrally spread by a binary pseudo-random sequence can be detected provided that a correlation is performed with a local signal at the same frequency and spread by the same sequence. In addition, the spreading sequence of the local signal must be synchronous with that of the received satellite signal. These conditions being combined, the position of the code of the local signal, commonly called the pseudo-distance, is the image of the propagation time. Using data from the navigation message of at least four satellites, the position of the receiver can be determined from these pseudo-distances.

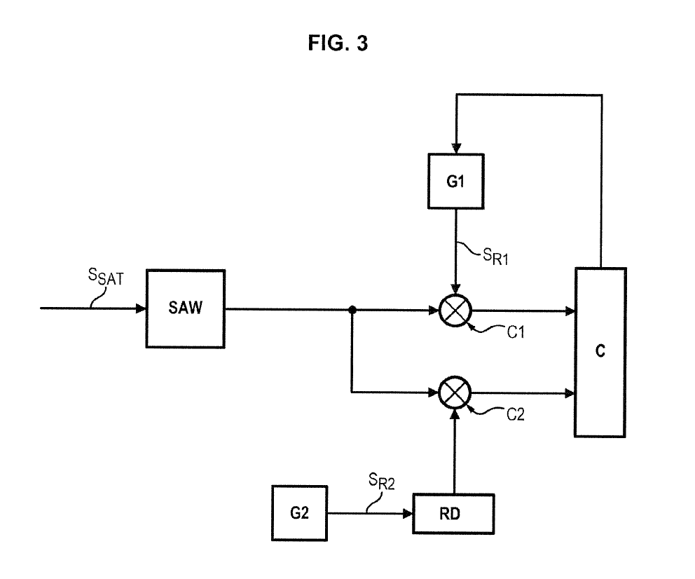

With reference to FIG. 3 the GNSS receiver, as is conventional, downstream of the SAW filter of the channel filter, comprises a plurality of tracking channels each associated with a satellite, and in each channel there is a tracking loop controlled by at least one control correlator C1 centred on a correlation peak between a spreading code of the signal S_{SAT} transmitted by the satellite and a local replica of said code S_{RI} generated by a replica signal generator G1 integrated in the receiver.

In reality, as is known, each tracking channel comprises three correlators supplied with a punctual replica of the spreading code (so-called “Prompt” correlator) having early offset by D/2 chip from the spreading code (so-called “Early correlator”) and late offset by D/2 chip (so-called “Late” correlator). The tracking loop of the code permanently maintains the “Prompt” correlator on the correlation peak by subjecting the generation of the replica of the code to the “zero” of the characteristic function “Early” minus “Late”. In the present description, the “Prompt” correlator is designated by the term control correlator.

The tracking loop of a channel therefore allows tracking of the signal along the single path and, by means of a computer C illustrated here as also being in charge of ensuring control of the tracking loop, infers the pseudo-distance to the satellite corresponding to its single path in the SAW filter.

According to the invention when tracking the satellite signal (single path) the GNSS receiver of the invention, via a channel allocator, positions a second channel at the same frequency as the tracking channel to identify the signal of the triple path.

More specifically, the GNSS receiver of the invention comprises a second replica generator G2 feeding a shift register RD configured to generate several local replicas of said spreading code shifted from one another so as to cover a time window corresponding to twice the uncertainty, typically in the order of ±10 ns, of an estimated propagation time for direct propagation through the filter channel.

The GNSS receiver further comprises a second correlator C2 offset from the control correlator by a time corresponding to twice said estimated propagation time for direct propagation through the channel filter, said second correlator being configured to perform the correlation between the spreading code of the signal transmitted by the satellite and said local replicas generated by the shift register, and to detect a correlation peak, said correlation peak corresponding to the acquisition of the signal transmitted by the satellite and propagated in the channel filter along a triple indirect path.

Therefore to determine the triple path signal the time slots are investigated that are adjacent to the offset of the second correlator C2 (offset from the control correlator C1 by a time corresponding to an estimate of twice the direct passing propagation time), these time slots covering twice the uncertainty of this estimate.

The computer C is also configured to compute the pseudo-distance to the satellite corresponding to its triple path in the SAW filter using the correlation peak of the second correlator C2. The computer C is also configured to compute the direct path propagation time through the channel filter by dividing by two the difference between the pseudo-distance to the satellite corresponding to its single path and the pseudo-distance to the satellite corresponding to its triple path.

Precise knowledge of this propagation time allows a significant improvement in the time and position accuracy of a GNSS receiver. Metric accuracy can therefore be reached in dual-frequency P code.

As is known per se the control correlator C1 and the second correlator C2 integrate the correlation results over an integration time. To allow adequate detection of the signal of the triple path which is of lower power than the signal of the single path, the integration time of the second correlator is longer than the integration time of the control correlator. For example, the integration time of the second correlator is in the order of one second when that of the control correlator is in the order of one millisecond.

In the foregoing a description was given of measurement of the propagation time of the SAW filter for a tracking channel associated with a satellite. This measurement may evidently be used for the different tracking channels fed by the same SAW filter.

It will be noted that for multi-constellation reception this measurement has to be performed for each of the GNSS bands used (L1, L2, L5 for GPS; E1, E5, E5 for GALILEO).

For reception on several antennas it will be noted that this measuring must be performed for each receiver chain associated with an antenna. With the invention it is therefore possible to track a satellite signal from one antenna to another in continuous manner. The tracking of the satellite signal can also be switched from one antenna to another, said switching finding particular application to rotating carriers (rocket, missile for example).

It will be ascertained that the invention also proves to be advantageous in that measurement of the triple path is performed under identical conditions to those of operational needs (connected antenna, visibility of satellites . . . ). It does not require any external measuring means and also overcomes the restraint of factory return for periodical calibration.

The invention also allows continuous measurement and in real time of the propagation time of the channel filter, thereby allowing real-time correction of pseudo-distance measurements which are flawed with errors related to uncertainty of propagation time in the channel filter. Continuous measurement in particular allows consideration to be given to temperature deviations for example during cold start of the receiver followed by warm-up. The real-time performance of measurement makes it possible not to have any interruption in the receiving of GNSS signals.

It will be appreciated that the invention is not limited to a GNSS receiver but also extends to a method for determining the propagation time of a signal transmitted by a satellite in a receiver of a satellite positioning system, the receiver comprising:

a channel filter comprising an input transducer and an output transducer, wherein the propagation of a signal transmitted by a satellite and received by the receiver travels along a direct path corresponding to direct passing between the input and output transducers and along indirect paths corresponding to 2n+1 times the direct path due to multiple reflections on the input and output transducers, n being an integer greater than or equal to 1;

downstream of the channel filter, a tracking loop controlled by a control correlator centred on a correlation peak between a spreading code of the signal transmitted by the satellite and a local replica (S_{R1}) of said code generated by the receiver, the method being characterized by the implementation of the following steps:

generation of several local replicas of said spreading code shifted from one another so as to cover a time window corresponding to twice the uncertainty of an estimated propagation time for direct propagation through the channel filter;

correlation, by means of a second correlator offset from the control correlator by a time corresponding to twice said estimated propagation time for direct propagation through the channel filter, between the spreading code of the signal transmitted by the satellite and said local replicas generated by the shift register, and detecting a correlation peak, said correlation peak corresponding to the acquisition of the signal transmitted by the satellite and propagated in the channel filter along a triple indirect path.

This method typically uses a continuous, real-time computing step to compute a pseudo-distance to the satellite using the correlation peak of the control correlator, of a pseudo-distance to the satellite using the correlation peak of the second correlator, and to compute a propagation time directly through the channel filter by dividing by two the difference between said pseudo-distances.

It may further comprise a correction step of said pseudo-distance to the satellite computed using the correlation peak of the control correlator taking into account said direct path propagation time through the channel filter.

1. A receiver for satellite positioning system, comprising:
a channel filter comprising an input transducer and an output transducer, wherein the propagation of a signal transmitted by a satellite and received by the receiver travels along a direct path corresponding to direct passing between the input and output transducers and along indirect paths corresponding to 2n+1 times the direct path due to multiple reflections on the input transducer and output transducer, n being an integer greater than or equal to 1;
downstream of the channel filter, a tracking loop controlled by a control correlator centred on a correlation peak between a spreading code of the signal transmitted by the satellite and a local replica of said code generated by the receiver,
wherein the receiver comprises:
a shift register configured to generate several local replicas of said spreading code shifted from one another so as to cover a time window corresponding to twice the uncertainty of an estimated propagation time for direct propagation through the channel filter;
a second correlator offset from the control correlator by a time corresponding to twice said estimated time of propagation directly through the channel filter, this second correlator being configured to perform correlation of the spreading code of the signal transmitted by the satellite with said local replicas generated by the shift register and to detect a correlation peak, said correlation peak corresponding to the acquisition of the signal transmitted by the satellite and propagated in the channel filter along a triple indirect path.

2. The receiver according to claim 1, further comprising a computer configured to compute a pseudo-distance to the satellite using the correlation peak of the control correlator and a pseudo-distance to the satellite using the correlation peak of the second correlator, said computer further being configured to compute the propagation time for direct propagation through the channel filter by dividing by two the difference between said pseudo-distances.

3. The receiver according to claim 1, wherein the control correlator and the second correlator integrate the correlation results over an integration time, the integration time of the second correlator being longer than the integration time of the control correlator.

4. The receiver according to claim 1, wherein the channel filter is a surface acoustic wave filter.

5. A method to determine the propagation time of a signal transmitted by a satellite in a receiver of a satellite positioning system, the receiver comprising:
a channel filter comprising an input transducer and an output transducer, wherein the propagation of a signal transmitted by a satellite and received by the receiver travels along a direct path corresponding to direct passing between the input transducer and output transducer and along indirect paths corresponding to 2n +1 times the direct path due to multiple reflections on the input transducer and output transducer, n being an integer greater than or equal to 1;
downstream of the channel filter, a tracking loop controlled by a control correlator centred on a correlation peak between a spreading code of the signal transmitted by the satellite and a local replica of said code generated by the receiver, wherein the method comprises the following steps:
generation of several local replicas of said spreading code shifted from one another so as to cover a time window corresponding to twice the uncertainty of an estimated time of propagation directly through the channel filter;
correlation, by means of a second correlator offset from the control correlator by a time corresponding to twice said estimated time of propagation directly through the channel filter, between the spreading code of the signal transmitted by the satellite and said local replicas generated by the shift register and detection of a correlation peak, said correlation peak corresponding to the acquisition of the signal transmitted by the satellite and propagated in the channel filter along a triple indirect path.

6. The method according to claim 5, further comprising a continuous, real-time computing step to compute a pseudo-distance to the satellite using the correlation peak of the control correlator, a pseudo-distance to the satellite using the correlation peak of the second correlator, and the direct path propagation time through the channel filter by dividing by two the difference between said pseudo-distances.

7. The method according to claim 6, further comprising a correction step to correct said pseudo-distance to the satellite computed using the correlation peak of the control correlator, taking into account said direct path propagation time through the channel filter.
